(19) United States
(12) Patent Application Publication
(10) Pub. No.: US 2022/0272049 A1
(43) Pub. Date: Aug. 25, 2022

(54) DISAGGREGATED DATA CENTER RESOURCE MANAGEMENT METHOD AND APPARATUS

(71) Applicant: Electronics and Telecommunications Research Institute, Daejeon (KR)

(72) Inventors: Kyeong-Eun HAN, Daejeon (KR); Chansung PARK, Sejong-si (KR); Daeub KIM, Daejeon (KR); Jongtae SONG, Daejeon (KR); Ji Wook YOUN, Daejeon (KR)

(73) Assignee: Electronics and Telecommunications Research Institute, Daejeon (KR)

(21) Appl. No.: 17/515,648

(22) Filed: Nov. 1, 2021

(30) Foreign Application Priority Data
Feb. 19, 2021 (KR) 10-2021-0022578

(51) Int. Cl. H04L 12/911; H04L 12/923; H04L 12/927; H04L 12/721

(52) U.S. Cl. CPC H04L 47/781; H04L 47/762; H04L 47/801; H04L 45/62

(57) ABSTRACT

Disclosed are a disaggregated data center resource management method and apparatus. A resource management method in a disaggregated data center includes receiving a resource allocation request from a client; generating allocated resource information about a computing resource and a memory resource which configure a virtual server in one rack of the data center according to the resource allocation request and optical path setting information for optical path connection of the computing resource and the memory resource; updating a resource management table for the computing resource and the memory resource; and transmitting a resource connection setting message including the allocated resource information and the optical path setting information to the computing resource and the memory resource.

### CROSS-REFERENCE TO RELATED APPLICATION

This application claims the benefit of Korean Patent Application No. 10-2021-0022578 filed on Feb. 19, 2021, in the Korean Intellectual Property Office, the entire disclosure of which is incorporated herein by reference for all purposes.

### BACKGROUND

### 1. Field of the Invention

The following disclosure relates to a disaggregated data center resource management method and apparatus.

### 2. Description of the Related Art

In many applications of a data center, unequal resource distribution which intensively use a memory, or a CPU is significant. Because of this, server-oriented data centers of the related art in which resources such as a CPU or a memory are fixed for one server have used only 30% to 40% of total resources. Further, in the server-oriented data center of the related art, even though various resources which configure the server generally have different lifespans and specifications, when specific equipment is upgraded or broken, the entire server is being replaced.

Recently, as a technique for solving the problems of the data center and sharing the unequally distributed resources, a disaggregated resource-based data center in which the resources are configured as one pool to be used is getting attention. Currently, the CPU/GPU and storage are partially disaggregated and recently, disaggregation between the CPU and the memory is being studied for full disaggregation. The low latency between the CPU and the memory is likely to be provided by a high-speed optical switch. In order to remotely access and use the memory resource, a latency time between the disaggregated computing (dComp) module and a disaggregated memory (dMem) module needs to be very low. Currently, in the server-oriented data center, an access delay time for a computing module (Comp) of the server to read/write (R/W) to its local memory is within 700 to 760 ns. Accordingly, only when the delay of the dComp module and the dMem module satisfy at least the access delay time, the performance degradation is minimized, and the resource may be efficiently used. For the purpose of the optical disaggregation, in order to satisfy the delay requirement, an optical circuit switch is used.

In the disaggregated data center, when a resource is requested by a specific request, a computing device dComp and a specific memory dMem which are divided into a computing pool and a memory pool are allocated and are connected via a network to configure one virtual server. Accordingly, unlike the existing data center, a technique which does not manage the computing and memory resources by one server, but manages and controls a network resource, computing and memory resources, which connect distributed resources in the unit of one rack, and a virtual server which is generated by combining the resources is requested. Each shared resource is allocated and then serves as a specific virtual server and when the usage thereof is completed, the shared resource is released. By doing this, a limited data center resource may be efficiently used.

The above description is information the inventor(s) acquired during the course of conceiving the present disclosure, or already possessed at the time, and is not necessarily art publicly known before the present application was filed.

### SUMMARY

Example embodiments may provide a technique which is capable of efficiently managing a plurality of computing and memory resources and network resources which are far apart in a rack in a disaggregated data center.

Example embodiments may efficiently use the resources of the data center and increase a network performance and a usage rate.

However, the technical aspects are not limited to the aforementioned aspects, and other technical aspects may be present.

According to an aspect of the present disclosure, a resource management method in a disaggregated data center includes receiving a resource allocation request from a client; generating allocated resource information about a computing resource and a memory resource which configure a virtual server in one rack of the data center according to the resource allocation request and optical path setting information for optical path connection of the computing resource and the memory resource; updating a resource management table for the computing resource and the memory resource; and transmitting a resource connection setting message including the allocated resource information and the optical path setting information to the computing resource and the memory resource.

The method may further include transmitting a control signal for controlling the optical path to an optical switch which connects between the computing resource and the memory resource.

The method may further include transmitting a resource information report ready message which notifies resource information collection of the computing resource and the memory resource to the computing resource and the memory resource.

The method may further include receiving a resource information report message including resource information generated in response to the resource information report ready message from the computing resource and the memory resource.

The method may further include updating the resource information based on a field indicating whether to update the resource information included in the resource information report message.

The method may further include receiving a resource release request from the client; and releasing an optical path of the computing resource and the memory resource according to the resource release request.

The method may further include transmitting a resource connection release message which notifies resource connection release according to the release of the optical path only to the computing resource.

The method may further include additionally allocating or partially releasing a memory of the memory resource to or from the computing resource in response to an allocated memory scale-up request or an allocated memory release request transmitted from the client; and updating the resource management table according to additional allocation or partial release.

The optical path setting information includes an ID of a resource, a connection port of the resource, a port number of an optical switch which connects a resource, and wavelength information, and the allocated resource information includes a capacity, a start address, and an end address of the allocated memory.

According to another aspect of the present disclosure, an apparatus of managing a resource in a disaggregated data center includes a memory which stores one or more instructions; and a processor which executes the instruction, and when the instruction is executed, the processor receives a resource allocation request from a client, generates allocated resource information about a computing resource and a memory resource which configure a virtual server in one rack of the data center according to the resource allocation request and optical path setting information for optical path connection of the computing resource and the memory resource, updates a resource management table for the computing resource and the memory resource, and transmits a resource connection setting message including the allocated resource information and the optical path setting information to the computing resource and the memory resource.

The processor may transmit a control signal for controlling the optical path to an optical switch which connects between the computing resource and the memory resource.

The processor may transmit a resource information report ready message which notifies resource information collection of the computing resource and the memory resource to the computing resource and the memory resource.

The processor may receive a resource information report message including resource information generated in response to the resource information report ready message from the computing resource and the memory resource.

The processor may update the resource information based on a field indicating whether to update the resource information included in the resource information report message.

The processor may receive a resource release request from the client and release an optical path of the computing resource and the memory resource according to the resource release request.

The processor may transmit a resource connection release message which notifies resource connection release according to the release of the optical path only to the computing resource.

The processor may additionally allocate or partially release a memory of the memory resource to or from the computing resource in response to an allocated memory scale-up request or an allocated memory release request transmitted from the client and update the resource management table according to the additional allocation or partial release.

The optical path setting information may include an ID of a resource, a connection port of the resource, a port number of an optical switch which connects a resource, and wavelength information, and the allocated resource information may include a capacity, a start address, and an end address of the allocated memory.

According to another aspect of the present disclosure, a disaggregated data center includes an optical disaggregation management apparatus which manages a resource in the data center, the optical disaggregation management apparatus includes: a memory which stores one or more instructions; and a processor which executes the instruction, and when the instruction is executed, the processor receives a resource allocation request from a client, generates allocated resource information about a computing resource and a memory resource which configure a virtual server in one rack of the data center according to the resource allocation request and optical path setting information for optical path connection of the computing resource and the memory resource, updates a resource management table for the computing resource and the memory resource, and transmits a resource connection setting message including the allocated resource information and the optical path setting information to the computing resource and the memory resource.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a schematic block diagram of a data center according to an example embodiment;

FIG. 2 illustrates a connected structure of configurations in a rack;

FIG. 3 is a view for explaining a function structure of an optical disaggregation management apparatus;

FIG. 4 illustrates a flowchart for explaining a resource management and network connection control operation of an optical disaggregation management apparatus;

FIG. 5 illustrates an example of a message format for resource management and network connection control according to an example embodiment;

FIG. 6 illustrates a flowchart for explaining a resource information collecting and updating operation;

FIG. 7 illustrates an example of a structure of a resource information report message;

FIG. 8 illustrates an example of a structure of a resource information report response message;

FIG. 9 illustrates a flowchart for explaining a resource connection and release operation;

FIG. 10 illustrates an example of a structure of a resource connection setting message;

FIG. 11 illustrates an example of a structure of a resource connection setting response message;

FIG. 12 illustrates an example of a structure of a resource connection release message;

FIG. 13 illustrates an example of a structure of a resource connection release response message;

FIG. 14 illustrates a flowchart for explaining a dynamic additional memory allocation and release operation; and

FIG. 15 is a schematic block diagram of an optical disaggregation management apparatus.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. When describing the example embodiments with reference to the accompanying drawings, like reference numerals refer to like elements and a repeated description related thereto will be omitted.

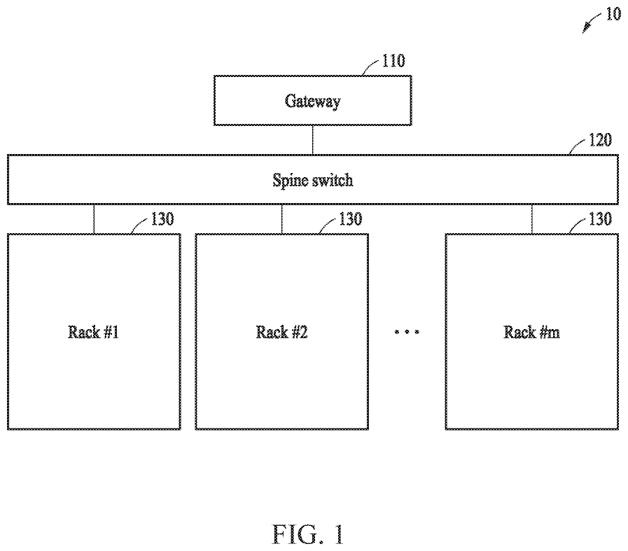

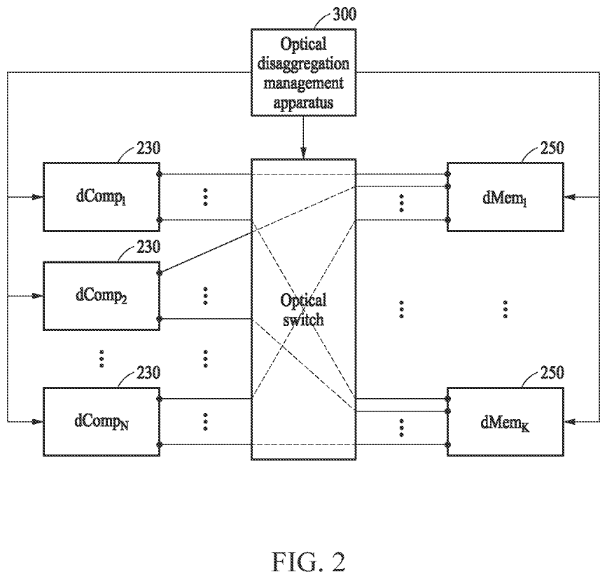

FIG. 1 is a schematic block diagram of a data center according to an example embodiment and FIG. 2 illustrates a connected structure of configurations in a rack.

A data center 10 may include a gateway 110, a spine switch 120, and a plurality of racks 130. The data center 10 may be interconnected with an external network via the gateway 110 and the spine switch 120 may connect the plurality of racks 130.

The data center 10 may be a disaggregated data center. Unlike a server-oriented data center of the related art in which a computing resource and a memory resource are locally connected to a single board, the data center 10 may have a structure in which a computing resource and a memory resource are configured by different boards to be remotely connected.

A rack 130 which configures a local network of the data center 10 may include an optical switch 210, a plurality of disaggregated computing (dComp) modules 230, a plurality of disaggregated memory (dMem) modules 250, and an optical disaggregation management (ODM) apparatus 300. In each rack 130 of the data center 10, disaggregated computing and memory resources (for example, the dComp module 230 and the dMem module 250) are connected via the optical switch 210 to provide a disaggregated resource management and network connection control method, thereby efficiently using the resources. According to the example embodiments, the disaggregated data center 10 efficiently may manage a specific resource and a network resource of a computing pool and a memory pool which are spaced apart from each other in one rack 130.

Even though FIG. 2 illustrates each rack 130 in which the same type of modules have the same connection structure, each rack 130 may include different types of modules and the modules may be disposed to have different connection structures.

The dComp module 230 is a module which performs various computational operations (for example, computational tasks) and may include a CPU (for example, a multi-core processor, not illustrated) and optical transceivers (not illustrated). The dComp module 230 may use a local memory to perform the computational task and if necessary, use a memory of the dMem module 250.

The dMem module 250 is a large capacity memory device configured by a plurality of memories and may provide a memory access function (for example, read and write) according to a request of the dComp module 230. The dMem module 250 is a memory pool which is shared by the dComp modules 230 and may include a memory read/write control device (for example, a controller or a memory controller, not illustrated), a plurality of memories (not illustrated) connected thereto, and optical transceivers (not illustrated).

The optical switch 210 may connect the dComp module 230 to one or more dMem modules 250. The optical switch 210 may switche and output optical signals to different output ports according to a wavelength of an input optical signal. Since a switching wavelength circulates according to an input port, even though wavelength division-multiplexed optical signals configured with the same wavelengths are input to different input ports, the optical switch 210 may suppress the same wavelength signal from being output to the same port. Accordingly, the switching may be performed without interference (or collision) between optical signals having the same wavelength. The optical switch 210 may be implemented by a high-speed optical circuit switch (OCS) to provide a low latency. Further, the optical switch 210 may be implemented by an arrayed wavelength grating (AWG) switch.

A plurality of dComp modules 230 may be connected to K dMem modules 250 via the optical switch 210. Even though in FIG. 2, N dComp modules 250 (for example, N is a natural number larger than 1) and K dMem modules 250 (for example, K is a natural number larger than 1) are illustrated, it is not limited thereto, and N and K may be equal to each other or different from each other. The number of dComp modules 230 and the number of dMem modules 250 which configure the connection may be equal to each other or different from each other.

One dComp module 230 may be connected to each dMem module 250 via a separate fixed port. For example, the number of ports of each dComp module 230 is equal to the number of dMem modules 250 connected to the optical switch 210 and as the optical switch 210, (N×K)×(N×K) switches (for example, switches having N×K input ports and N×K output ports) may be used. At this time, one dComp module 230 may access one or more dMem modules 250 to use the memory resource. Further, the plurality of dComp modules 230 may access a resource of one dMem module 250 (for example, a memory) according to each allocated memory range (for example, determined as an allocated memory capacity, a start address, and an end address).

The optical disaggregation management apparatus 300 may collect resource information about the dComp module 230, resource information about the dMem module 250, and resource information about the optical switch 210 (for example, optical switch information). The optical disaggregation management apparatus 300 may manage and control network connection and sharing resources between resources (for example, a computing resource and a memory resource) using the collected resource information. The optical disaggregation management apparatus 300 may be implemented by an ODM or a server for an ODM.

The optical disaggregation management apparatus 300 may manage a resource management table using the collected resource information. The resource management table may include a computing resource management table, a memory resource management table, an optical switch table, and a computing-memory interconnection table. The computing resource management table may include resource information about the dComp module 230, the memory resource management table may include resource information about the dMem module 250, and the optical switch table may include resource information about the optical switch 210. The computing-memory interconnection table may include optical path setting information between the dComp module 230 and the dMem module 250.

The optical disaggregation management apparatus 300 may receive a resource allocation request (for example, including capacities of a computing resource and a memory resource) from a client and determine allocated resource information about one or more dComp modules 230 and one or more dMem modules 250 which configure a virtual server according to the resource allocation request. The optical disaggregation management apparatus 300 may generate the optical path setting information for connection of an optical path of one or more dComp modules 230 and one or more dMem modules 250 which configure a virtual server and update the resource management table.

The optical disaggregation management apparatus 300 may transmit the optical path setting information and the allocated resource information to one or more dComp modules 230 and one or more dMem modules 250 which configure a virtual server and transmit a control signal to the optical switch 210 to control an optical path of the dComp module 230 and the dMem module 250. The control signal may include the connection information about the optical path of the dComp module 230 and the dMem module 250.

The dComp module 230 may transmit a read/write (R/W) request (for example, an instruction) through the port corresponding to the optical path set between the allocated dMem module 250 to use the allocated remote memory. At this time, in the case of the writing, the dComp module 230 may transmit data together with a write request. The dMem module 250 may process a request (for example, a read/write (R/W) request) received from the dComp module 230 and perform a read and write instruction on the memory allocated to the dComp module 230. At this time, the dMem module 250 may transmit an instruction and memory address information (for example, a memory start address and a memory end address) to the memory controller included in the dMem module 250 to perform the memory read/write (R/W). In the case of the read instruction, the dMem module 250 may transmit data read from the memory to the dComp module 230 and in the case of the write instruction, write the received data in the memory and then transmit ack to the dComp module 230. When the task between the dComp module 230 and the dMem module 250 ends, the optical disaggregation management apparatus 300 may release the optical path between the resources (for example, the computing resource of the dComp module 230 and the memory resource of the dMem module 250).

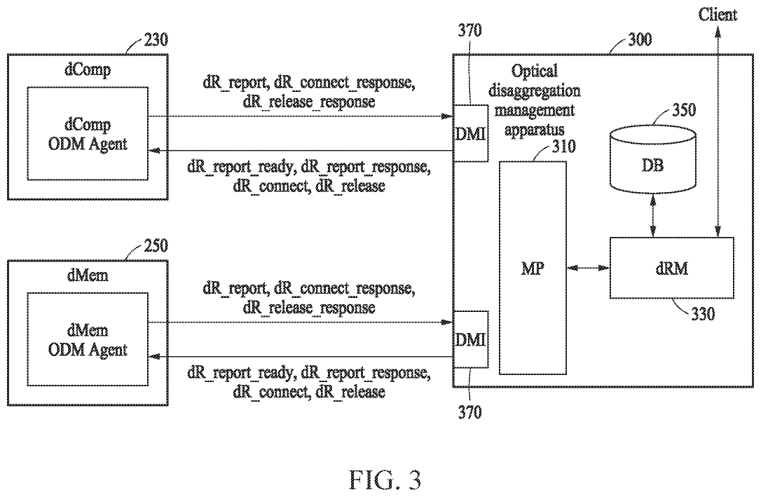

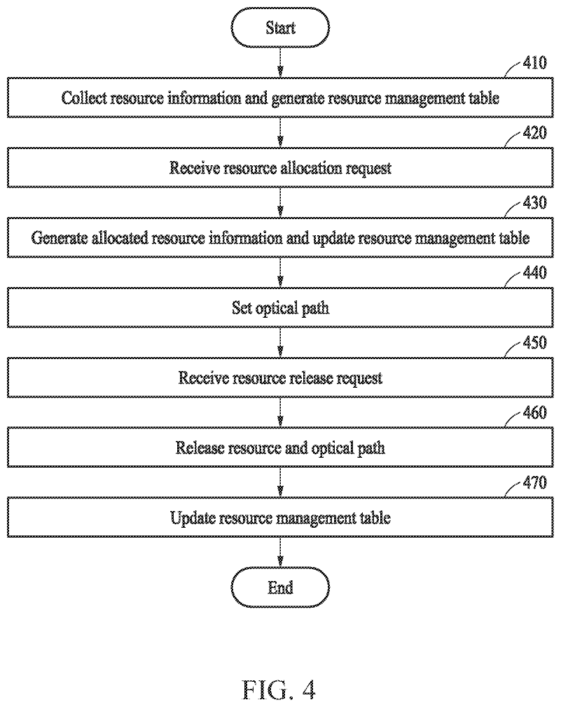

FIG. 3 is a view for explaining a function structure of an optical disaggregation management apparatus and FIG. 4 illustrates a flowchart for explaining a resource management and network connection control operation of an optical disaggregation management apparatus.

The optical disaggregation management apparatus 300 may include a message processor (MP) 310, a disaggregated resource manager (dRM) 330, and a resource management DB 350. The optical disaggregation management apparatus 300 may manage disaggregated computing and memory resources and communicate with ODM agents included in the dComp module 230 and the dMem module 250 to set and release the optical path between the computing resource and the memory resource. The ODM agents may be executed by processors (for example, a CPU, a controller, etc.) included in the dComp module 230 and the dMem module 250. The communication between the optical disaggregation management apparatus 300 and the ODM agents may be performed by transmitting and receiving a message via the disaggregated management interface (DMI) 370.

The resource management and network connection control operations 410 to 470 of the optical disaggregation management apparatus 300 is as follows.

In an operation 410, the optical disaggregation management apparatus 300 may collect resource information and generate the resource management table based on the collected resource information. The optical disaggregation management apparatus 300 may manage information such as a capacity of a resource (for example, a computing and memory resource), the number of resources, and port and wavelength, optical switch information (for example, the number of input/output ports of the optical switch and wavelength information), network connection (for example, optical path) information of the computing resource and the memory resource, and available resource information, with the resource management table.

In an operation 420, the optical disaggregation management apparatus 300 may receive a resource allocation request from the client. The resource allocation request may be a request to allocate the computing resource and the memory resource which configure the virtual server.

In operations 430 and 440, the optical disaggregation management apparatus 300 may determine allocated resource information about one or more dComp modules 230 and one or more dMem modules 250 which configure the virtual server based on the resource management table according to the resource allocation request, update the resource management table (for example, a computing resource management table, a memory resource management table, a computing-memory interconnection table), and set an optical path between the dComp module 230 and the dMem module 250.

The optical disaggregation management apparatus 300 may transmit a resource connection setting message dR_connect including the optical path setting information and the allocated resource information to the ODM agents of the dComp module 230 and the dMem module 250 for connection between disaggregated resources. When the setting (for example, the optical path setting and the resource allocation setting) is completed, the ODM agents of the dComp module 230 and the dMem module 250 may transmit a resource connection setting response message dR_connect_response to the optical disaggregation management apparatus 300.

In an operation 450, the optical disaggregation management apparatus 300 may receive a resource release request from the client. The resource release request may be a request for releasing the computing resource and the memory resource which configure the virtual server when all the tasks of the configured virtual server end.

In an operation 460, the optical disaggregation management apparatus 300 may release the resource which configures the virtual server and release the optical path between the resources. The optical disaggregation management apparatus 300 may transmit a resource connection release message dR_release to the ODM agent of the dComp module 230 which is a resource of configuring the virtual server to release the resource. When the release (for example, the release of the set optical path and resource allocation) is completed, the ODM agent of the dComp module 230 may transmit the resource connection release response message dR_release_response to the optical disaggregation management apparatus 300.

In an operation 470, the optical disaggregation management apparatus 200 may update the resource management table. When the optical disaggregation management apparatus 300 may receive the resource connection release response message dR_release_response, the optical disaggregation management apparatus 300 may release the optical path connected between the dComp module 230 and the dMem module 250 and update the resource management table (for example, the computing resource management table, the memory resource management table, and the computing-memory interconnection table).

The optical disaggregation management apparatus 300 may perform an operation of dynamically additionally allocating a memory allocated to a specific dComp module 230 or dynamically releasing a part of the memory according to the request of the client. At this time, the memory resource which is additionally allocated or released may be a memory resource of a specific dComp module 230 and a dMem module 250 to which the optical path is already connected.

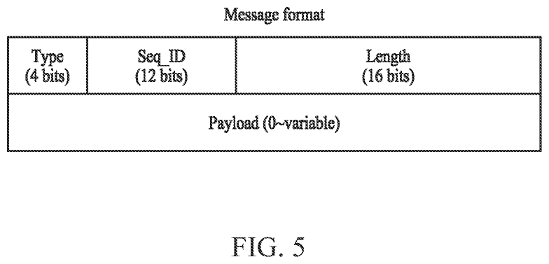

FIG. 5 illustrates an example of a message format for resource management and network connection control according to an example embodiment.

A message for resource management and network connection control may include a plurality of fields. A size of each field may vary according to a scale of a data center and a disaggregated resource, an optical switch size, and a network configuring method. Further, a size of each field may vary depending on a message type. The message for resource management and network connection control may include a resource information report ready message dR_report_ready, a resource information report message dR_report, a resource information report response message dR_report_response, a resource connection setting message dR_connect, a resource connection setting response message dR_connect_response, a resource connection release message dR_release, and a resource connection release response message dR_release_response.

A type field distinguishes a type of the message. For example, the resource information report ready message dR_report_ready (Type=0), the resource information report message dR_report (Type=1), the resource information report response message dR_report_response (Type=2), the resource connection setting message dR_connect (Type=3), the resource connection setting response message dR_connect_response (Type=4), a resource connection release message dR_release (Type=5), and the resource connection release response message dR_release_response (Type=6) may be distinguished according to each type value.

A sequence ID field Seq_id may be a field for inspecting a sequence of the transmitted message. A length field Length indicates a length of a payload and may be set in the unit of bytes. The payload field has a variable length and may include a message structure determined according to each message type and padding. The resource information report ready message dR_report_ready whose type field is 0 is a trigger message which notifies resource information collection, the payload is not included therein, and a value of a length field may be 0.

A resource management and network connection control operation according to the example embodiment may include a resource information collecting and updating operation, a resource connecting and releasing operation, and a dynamic additional memory allocating and releasing operation. The above-described operations may be performed by a message according to a message format of FIG. 5 corresponding to each operation. Message information input to the payload field may vary depending on a message type. As the optical switch 210, various switches may be used as well as AWG and additional information required to set a path may be added to the message other than port and wavelength information depending on the type of a switch to be used. Information exchanging through the message may be managed in the optical disaggregation management apparatus 300 and the ODM agents as information for resource and optical path connection. Hereinafter, for the convenience of description, it is assumed that the optical switch 210 is implemented by AWG.

Hereinafter, a resource management and network connection control operation and a message used therefor will be described in detail.

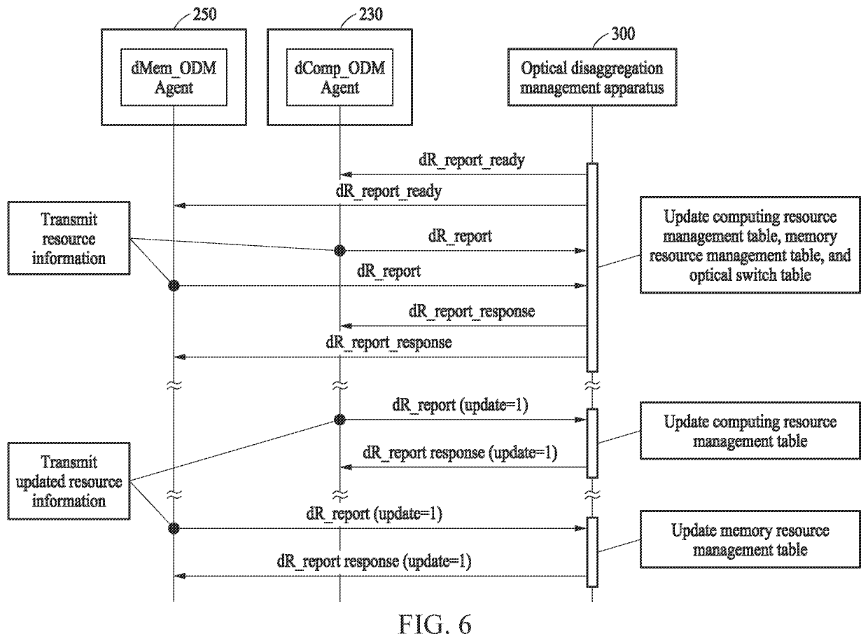

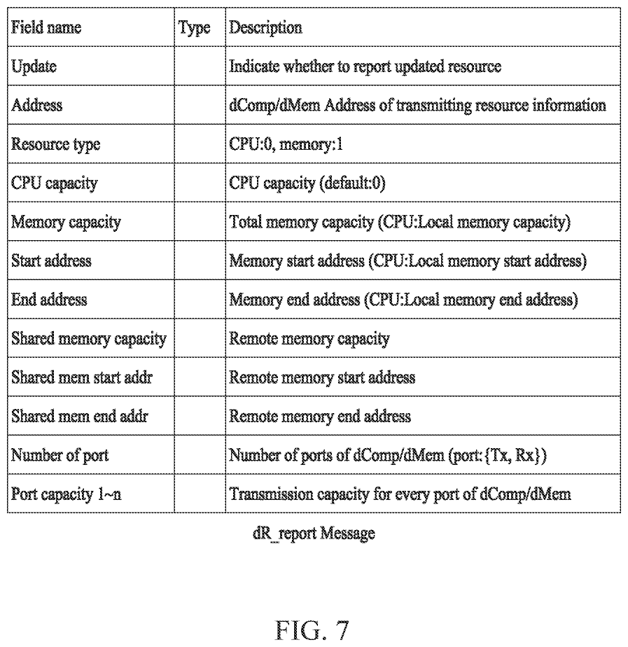

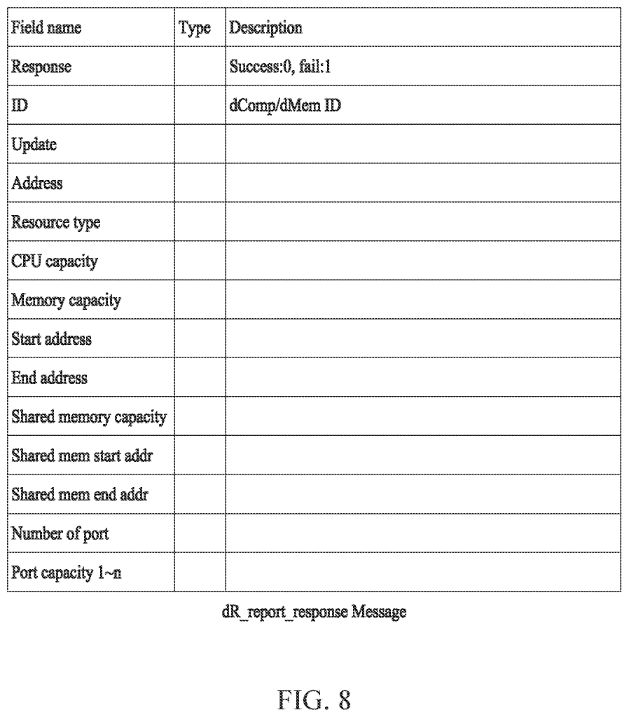

FIG. 6 illustrates a flowchart for explaining a resource information collecting and updating operation, FIG. 7 illustrates an example of a structure of a resource information report message, and FIG. 8 illustrates an example of a structure of a resource information report response message. FIG. 6 illustrates a resource information collecting and updating operation performed between the optical disaggregation management apparatus 300 and the ODM agent to collect and manage the resource information.

The optical disaggregation management apparatus 300 may transmit a resource information report ready message dR_report_ready to the ODM agents of the dComp module 230 and the dMem module 250 to collect the resource information. The resource information report ready message dR_report_ready may be a trigger message which notifies the resource information collection. The optical disaggregation management apparatus 300 may also collect resource information (for example, the number of input/output ports of the optical switch and wavelength information) about the optical switch 210.

The ODM agents of the dComp module 230 and the dMem module 250 may transmit the resource information report message dR_report including the resource information to the optical disaggregation management apparatus 300. The resource information report message dR_report may include fields of an address (for example, addresses of the dComp module 230/dMem module 250 which transmit resource information), a resource type (for example, a computing resource or a memory resource), computing resource information (for example, a capacity of a computing resource), memory resource information (for example, a capacity, a start address and an end address of the memory resource (in the case of the computing resource, a capacity, a start address, and an end address of a local memory)), shared memory information (for example, a capacity, a start address, and an end address of an allocated remote memory), and port information (for example, the number of ports of the dComp module 230/dMem module 250 and a transmission capacity per port). Further, the resource information report message dR_report may further include an update field indicating whether the resource (for example, resource information) is updated (for example, changed). An example of the structure of the resource information report message dR_report may be as illustrated in FIG. 7.

The optical disaggregation management apparatus 300 may generate (for example, register a resource or update a resource) the resource management table based on the resource information included in the resource information report message dR_report to store the resource management table in the DB 350. The optical disaggregation management apparatus 300 may manage (register and update) the resource information about the dComp module 230 in the computing resource management table, manage (for example, register and update) the resource information about the dMem module 250 in the memory resource management table, and manage (for example, register and update) the resource information about the optical switch 210 in the optical switch table.

The optical disaggregation management apparatus 300 may transmit the resource information report response message dR_report_response which indicates registration and/or update completion of the resources to the dComp module 230 and the dMem module 250 after reflecting (registering or updating) the resource information to the resource management table. The resource information report response message dR_report_response may include a field regarding a response (for example, success or fail) and ID (for example, ID of the dComp module 230/dMem module 250). An example of the structure of the resource information report response message dR_report_response may be as illustrated in FIG. 8.

When resource information which is already registered is changed, the ODM agent corresponding to the corresponding resource (for example, the dComp module 230 and the dMem module 250) may set an update field of the resource information report message dR_report to 1 and transmit the resource information report message dR_report including updated resource information to the optical disaggregation management apparatus 300. After updating the resource information of the resource, the optical disaggregation management apparatus 300 may set the update field of the resource information report response message dR_report_response to 1 to transmit the update field to the ODM agent corresponding to the corresponding resource (for example, the dComp module 230 and the dMem module 250).

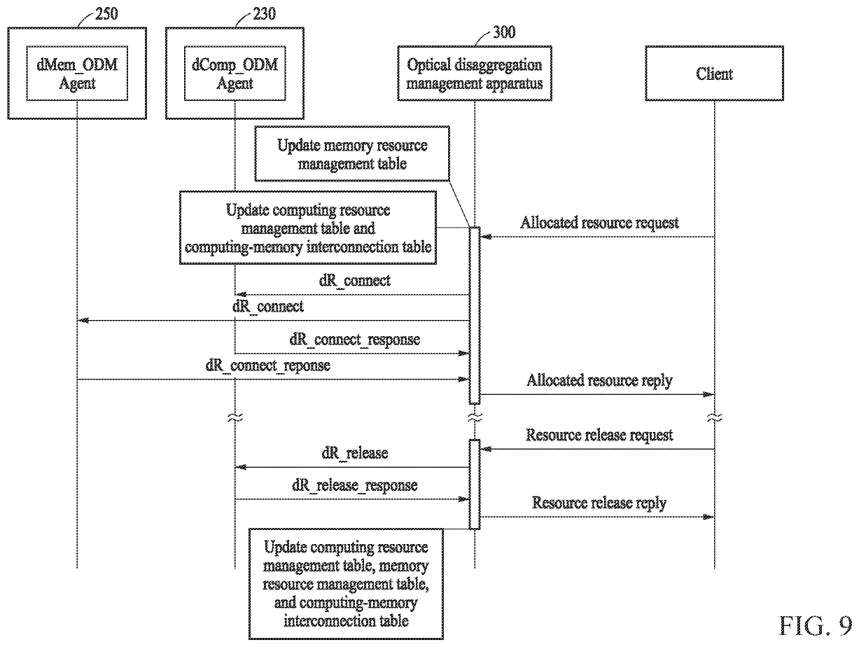

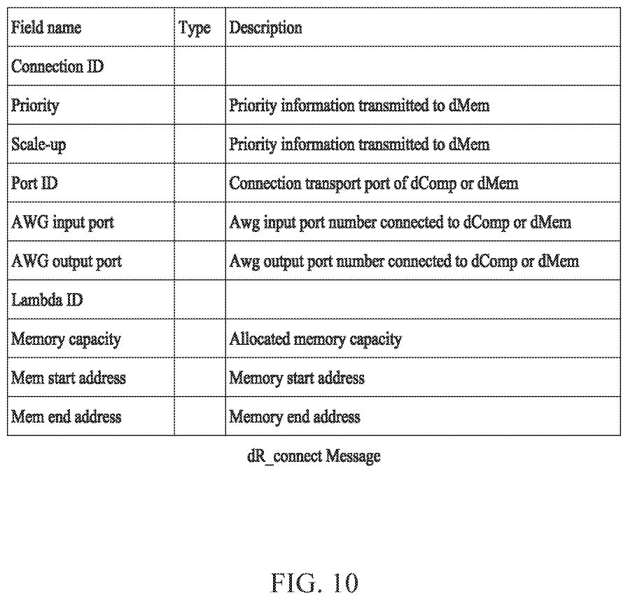

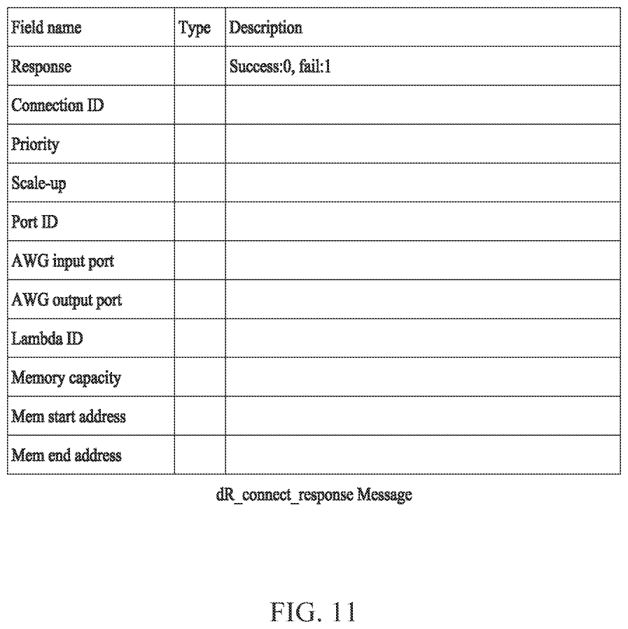

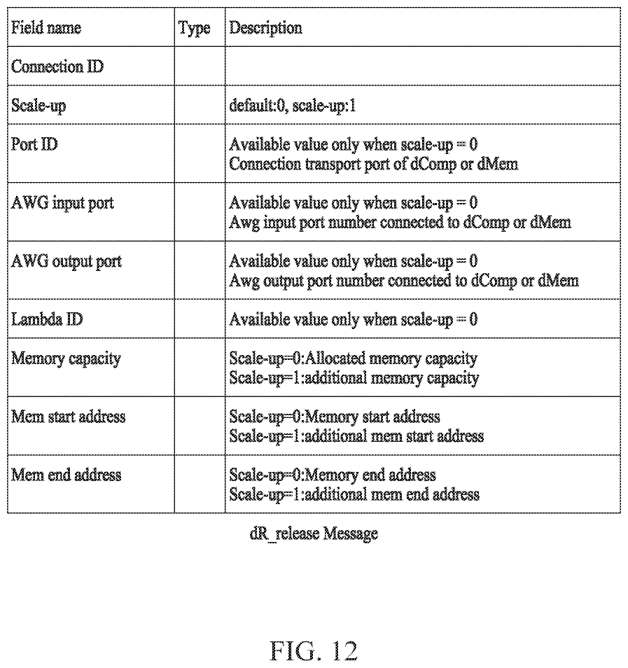

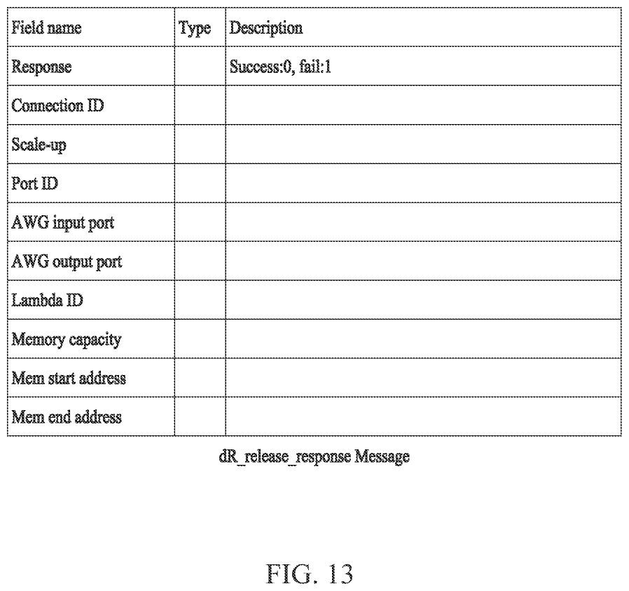

FIG. 9 illustrates a flowchart for explaining a resource connection and release operation, FIG. 10 illustrates an example of a structure of a resource connection setting message, FIG. 11 illustrates an example of a structure of a resource connection setting response message, FIG. 12 illustrates an example of a structure of a resource connection release message, and FIG. 13 illustrates an example of a structure of a resource connection release response message. FIG. 9 illustrates a resource connection operation and a resource release operation performed between the optical disaggregation management apparatus 300 and the ODM agent to connect and release the resource.

The optical disaggregation management apparatus 300 may receive a resource allocation request to configure a virtual server from the client.

The optical disaggregation management apparatus 300 may determine allocated resource information about one or more dComp module 230 and one or more dMem modules 250 which configure a virtual server according to the resource allocation request, based on the resource management table. Further, the optical disaggregation management apparatus 300 may set an optical path between the dComp module 230 and the dMem module 250 and generate optical path setting information based on a switch port and wavelength information.

The optical disaggregation management apparatus 300 may update the resource management table (for example, the computing resource management table and the memory resource management table) based on the allocated resource information and update the resource management table (for example, the computing-memory interconnection table) based on the optical path setting information.

The optical disaggregation management apparatus 300 may transmit a resource connection setting message dR_connect including one or more of the optical path setting information and the allocated resource information to the ODM agents of the dComp module 230 and the dMem module 250. The resource connection setting message dR_connect may be a message for connection between the disaggregated resources (for example, the computing resource and the memory resource).

The resource connection setting message dR_connect which is transmitted to the ODM agent of the dComp module 230 may include a field regarding the optical path setting information (for example, an ID of a dMem module 250 to be connected, a connection transport port of the dComp module 230, an input port number of the optical switch 210 connected to the dComp module 230, an output port number of the optical switch 210 connected to the dMem module 250, and wavelength information) and the allocated resource information (for example, an allocated memory capacity, an allocated memory start address, and an allocated memory end address). Further, the resource connection setting message dR_connect which is transmitted to the ODM agent of the dComp module 230 may further include a field (for example, a scale-up field) indicating whether to allocate an additional memory to a specific dComp module 230.

The resource connection setting message dR_connect which is transmitted to the agent of the dMem module 250 may include a field regarding the optical path setting information (for example, a connection transport port of the dComp module 230, an input port number of the optical switch 210 connected to the dComp module 230, an output port number of the optical switch 210 connected to the dMem module 250, and wavelength information) and/or the allocated resource information (for example, an allocated memory capacity, an allocated memory start address, and an allocated memory end address). Further, the resource connection setting message dR_connect which is transmitted to the agent of the dMem module 250 may further include a field regarding priority information (for example, a priority field) to be transmitted to the dMem module 250. An example of the structure of the resource connection setting message dR_connect may be as illustrated in FIG. 10.

The dComp module 230 and the dMem module 250 may set an optical path between the dComp module 230 and the dMem module 250 based on the information included in the resource connection setting message dR_connect. When the setting (for example, the optical path setting and the resource allocation setting) is completed, the ODM agents of the dComp module 230 and the dMem module 250 may transmit a resource connection setting response message dR_connect_response to the optical disaggregation management apparatus 300. The resource connection setting response message dR_connect_response includes a field regarding a response (for example, success or fail) and an example of the structure is as illustrated in FIG. 11.

The optical disaggregation management apparatus 300 may transmit a reply for the resource allocation request (allocated resource reply) to the client in response to the resource connection setting response message dR_connect_response transmitted from the dComp module 230 and the dMem module 250.

When all the tasks which are performed with the allocated resource are completed, the client may transmit a resource release request to the optical disaggregation management apparatus 300.

The optical disaggregation management apparatus 300 may transmit a resource connection release message dR_release to the ODM agent of the dComp module 230 which is a resource of configuring the virtual server to release the resource. The resource connection release message dR_release may include the information which is substantially the same as information transmitted by means of the resource connection setting message dR_connect. The resource connection release message dR_release may further include a field (for example, a scale-down field) indicating whether to release the memory from the specific dComp module 230. An example of the structure of the resource connection release message dR_release may be as illustrated in FIG. 12.

The ODM agent of the dComp module 230 may release the set optical path and the allocated resource in response to the resource connection release message dR_release and transmit the resource connection release response message dR_release_response to the optical disaggregation management apparatus 300. The resource connection release response message dR_release_response may include a field regarding a response (for example, success or fail) and an example of the structure may be as illustrated in FIG. 13.

The optical disaggregation management apparatus 300 may release the resource (for example, the computing resource and the memory resource) of the dComp module 230 and the dMem module 250 used to configure a virtual server in response to the resource connection release response message dR_release_response, release the optical path connected between the dComp module 230 and the dMem module 250, and update the resource management table (for example, the computing resource management table, the memory resource management table, and the computing-memory interconnection table).

The optical disaggregation management apparatus 300 may transmit a reply for the resource release request (resource release reply) to the client.

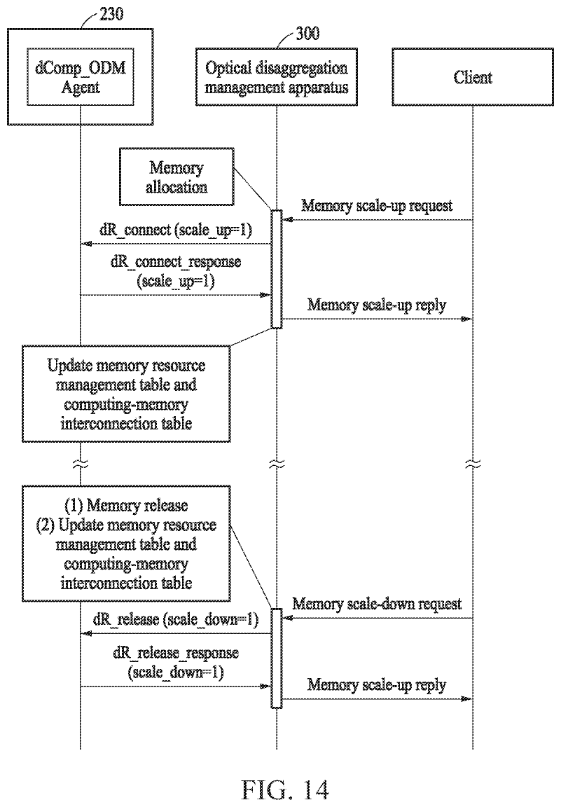

FIG. 14 illustrates a flowchart for explaining a dynamic additional memory allocation and release operation. FIG. 14 illustrates a dynamic additional memory allocating operation and a releasing operation performed between the optical disaggregation management apparatus 300 and the ODM agent to dynamically additionally allocate and release the memory. For the dynamic additional memory allocating operation and releasing operation, the resource connection setting message dR_connect, the resource connection setting response message dR_connect_response, the resource connection release message dR_release, and the resource connection release response message dR_release_response which have been described with reference to FIGS. 9 to 13 may be used. In order to perform the dynamic additional memory allocating operation and the releasing operation, the scale field (for example, a scale-up field and a scale-down field) may be set in the message to be used.

When the client wants to allocate an additional memory to the specific dComp module 230, the client may transmit the allocated memory scale-up request to the optical disaggregation management apparatus 300. The optical disaggregation management apparatus 300 may additionally allocate (for example, additionally scale-up allocate) the memory of the dMem module 250 which is connected to the dComp module 230 in response to the allocated memory scale-up request and transmit the additional allocated resource information (for example, an additional memory capacity, an additional memory start address, and an additional memory end address) to a specific dComp module 230 by means of the resource connection setting message dR_connect (for example, scale-up=1 in a scale-up field). The ODM agent of the specific dComp module 230 may update the additional allocated resource information (for example, additionally allocated memory information) and then transmit the resource connection setting response message dR_connect_response to the optical disaggregation management apparatus 300. The optical disaggregation management apparatus 300 may update the resource management table (for example, the memory resource management table, the computing-memory interconnection table) in response to the resource connection setting response message dR_connect_response and transmit the reply (for example, a setting completion reply) for the allocated memory scale-up request (memory scale-up reply) to the client.

When the client wants to release a part of the memory allocated to the specific dComp module 230, the client may transmit an allocated memory scale-down request to the optical disaggregation management apparatus 300. The optical disaggregation management apparatus 300 may set released allocated resource information (for example, released memory information, released memory start information, released memory end address) by means of a resource connection release message dR_release (for example, scale-down is 1 in a scale-down field) to transmit the released allocated resource information to the ODM agent of the dComp module 230. The ODM agent of the specific dComp module 230 may update the released allocated resource information (for example, memory information to be leased) and then transmit the resource connection release response message dR_release_response to the optical disaggregation management apparatus 300. The optical disaggregation management apparatus 300 may update the resource management table (for example, the memory resource management table, the computing-memory interconnection table) in response to the resource connection release response message dR_release_response and transmit the reply (for example, a setting completion reply) for the allocated memory scale-down request (memory scale-down reply) to the client.

As described with reference to FIGS. 1 to 14, the resource management and network connection control method according to various example embodiments may provide a resource management and optical path control technique which share disaggregated computing and memory resources to increase a usage rate of the entire network and efficiently couple and access the computing and memory resources which are disaggregated for every resource pool. By doing this, a usage rate of a disaggregated data center network is increased, and a low latency remote memory access may be provided via an optical switch.

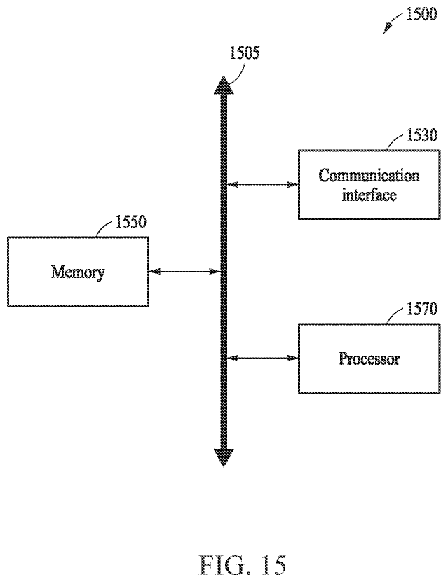

FIG. 15 illustrates another example of a schematic block diagram of an optical disaggregation management apparatus.

The optical disaggregation management apparatus 300 may include a communication interface 1530, a memory 1550, and a processor 1570. Individual configurations 1530 to 1570 of the optical disaggregation management apparatus 300 may communicate with each other via a bus 1505. The communication interface 1530 may be a disaggregated management interface DMI.

The memory 1550 may store instructions (for example, programs) executable by the processor 1570. For example, the instructions may include instructions for executing an operation of the processor 1570 and/or an operation of each configuration of the processor 1570.

Further, the memory 1550 may store the resource management table which has been described with reference to FIGS. 1 to 14. The resource management table may also be stored in a separate memory (not illustrated) which is distinguished from the memory 1550 or a database.

The processor 1570 may process data stored in the memory 1550. The processor 1570 may execute a computer readable code (for example, software) which is stored in the memory 1550 and instructions triggered by the processor 1570.

The processor 1570 may be a data processing device which is implemented by hardware having a circuit having a physical structure for executing desired operations. For example, the desired operations may include codes or instructions included in the program.

For example, the data processing device implemented by hardware may include a microprocessor, a central processing unit, a processor core, a multi-core processor, a multiprocessor, an application-specific integrated circuit (ASIC), and a field programmable gate array (FPGA).

The operation performed by the processor 1570 may be substantially the same as the operation of the optical disaggregation management apparatus 300 which has been described with reference to FIGS. 1 to 14. Each configuration (for example, the message processor 310 or the disaggregated resource manager 330) of the optical disaggregation management apparatus 300 may be executed by the processor 1570. Therefore, a detailed description will be omitted.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A resource management method in a disaggregated data center, the method comprising:
receiving a resource allocation request from a client;
generating allocated resource information about a computing resource and a memory resource which configure a virtual server in one rack of the data center according to the resource allocation request and optical path setting information for optical path connection of the computing resource and the memory resource;
updating a resource management table for the computing resource and the memory resource; and
transmitting a resource connection setting message including the allocated resource information and the optical path setting information to the computing resource and the memory resource.

2. The resource management method of claim 1, further comprising:
transmitting a control signal for controlling the optical path to an optical switch which connects between the computing resource and the memory resource.

3. The resource management method of claim 1, further comprising:
transmitting a resource information report ready message which notifies resource information collection of the computing resource and the memory resource to the computing resource and the memory resource.

4. The resource management method of claim 3, further comprising:
receiving a resource information report message including resource information generated in response to the resource information report ready message from the computing resource and the memory resource.

5. The resource management method of claim 4, further comprising:
updating the resource information based on a field indicating whether to update the resource information included in the resource information report message.

6. The resource management method of claim 1, further comprising:
receiving a resource release request from the client; and
releasing an optical path of the computing resource and the memory resource according to the resource release request.

7. The resource management method of claim 6, further comprising:
transmitting a resource connection release message which notifies resource connection release according to the release of the optical path only to the computing resource.

8. The resource management method of claim 1, further comprising:
additionally allocating or partially releasing a memory of the memory resource to or from the computing resource in response to an allocated memory scale-up request or an allocated memory release request transmitted from the client; and
updating the resource management table according to the additional allocation or partial release.

9. The resource management method of claim 1, wherein the optical path setting information includes an ID of a resource, a connection port of the resource, a port number of an optical switch which connects the resource, and wavelength information and the allocated resource information includes a capacity, a start address, and an end address of an allocated memory.

10. A non-transitory computer-readable storage medium storing instructions that, when executed by a processor, cause the processor to perform the resource management method of claim 1.

11. An apparatus of managing a resource in a disaggregated data center, the apparatus comprising:
a memory which stores one or more instructions; and
a processor which executes the instruction,
wherein when the instruction is executed, the processor receives a resource allocation request from a client, generates allocated resource information about a computing resource and a memory resource which configure a virtual server in one rack of the data center according to the resource allocation request and optical path setting information for optical path connection of the computing resource and the memory resource, updates a resource management table for the computing resource and the memory resource, and transmits a resource connection setting message including the allocated resource information and the optical path setting information to the computing resource and the memory resource.

12. The apparatus of claim 11, wherein the processor transmits a control signal for controlling the optical path to an optical switch which connects between the computing resource and the memory resource.

13. The apparatus of claim 11, wherein the processor transmits a resource information report ready message which notifies resource information collection of the computing resource and the memory resource to the computing resource and the memory resource.

14. The apparatus of claim 13, wherein the processor receives a resource information report message including resource information generated in response to the resource information report ready message from the computing resource and the memory resource.

15. The apparatus of claim 14, wherein the processor updates the resource information based on a field indicating whether to update the resource information included in the resource information report message.

16. The apparatus of claim 11, wherein the processor receives a resource release request from the client and releases an optical path of the computing resource and the memory resource according to the resource release request.

17. The apparatus of claim 16, wherein the processor transmits a resource connection release message which notifies resource connection release according to the release of the optical path only to the computing resource.

18. The apparatus of claim 11, wherein the processor additionally allocates or partially releases a memory of the memory resource to or from the computing resource in response to an allocated memory scale-up request or an allocated memory release request transmitted from the client and updates the resource management table according to the additional allocation or partial release.

19. The apparatus of claim 11, wherein the optical path setting information includes an ID of a resource, a connection port of the resource, a port number of an optical switch which connects the resource, and wavelength information and the allocated resource information includes a capacity, a start address, and an end address of an allocated memory.
